(19) United States
(12) Patent Application Publication
(10) Pub. No.: US 2006/0078786 A1
(43) Pub. Date: Apr. 13, 2006

(54) Battery case internal ventilation structure for controlling the temperature therein

(76) Inventor: Yi-Chieh Wu, Cingshuei Township (TW)

Correspondence Address: CHARLES E. BAXLEY, ESQ., 90 JOHN STREET, THIRD FLOOR, NEW YORK, NY, 10038, US

(21) Appl. No.: 11/091,857

(22) Filed: Mar. 28, 2005

(30) Foreign Application Priority Data
Oct. 7, 2004 (TW) 093130403

(51) Int. Cl. H01M 10/50; H01M 2/36; H01M 2/12

(52) U.S. Cl. 429/62; 429/72; 429/82

(57) ABSTRACT

The present invention relates to a battery case internal ventilation structure for controlling the temperature therein, wherein the fan and a temperature controller get power directly from the cells inside the battery case, so they can be operated independently. Whatever the cells are in use, or not in use, or being recharged, the fan can be turned on automatically to cool down the battery case whenever the temperature inside the battery case is over a predetermined reference.

### BACKGROUND OF THE INVENTION

1. Field of the Invention

The present invention relates to a battery case internal ventilation structure for controlling the temperature therein, and more particularly to a heat dissipating structure for a battery case that is likely to be attenuated in service life when subjected to high temperature.

2. Description of the Prior Arts

Along with the development of technology in battery industry, different battery modules (such as nicad battery, Ni-MH Battery, Li-ion battery and so on) have been widely used on many electric appliances, such as the notebook, the camera, and the like. These battery modules can be easily used, however they are high in production cost and the service life will be attenuated if subjected to high temperature. So far, the battery producer has not found any effective solution to this problem.

The battery's service life is highly susceptible to temperature changes. For example, the working temperature of the Li-ion battery ranges from −20° C. to 60° C., if the Li-ion battery is placed in an environment over 24 hours where the temperature is higher than 60° C. (whatever the battery is in use or not), the service life of the battery will be attenuated to below 30% of its initial value, and the Li-ion battery cannot be fully recharged any more. Hence, temperature not only has a great bearing on the battery's service life, but also will affect the electric appliances using the battery.

For example, usually, people like to place the notebook in the car, and in summer, the car gets very hot under the sun and the temperature therein can be increased up to 70-80° C. In this case, the service life of and the effective function of the notebook's battery inside the car will be substantially attenuated, thus resulting in a permanent damage to the battery.

For another example of the battery module used on the electric bicycle, the temperature in summer ranging from 30-40° C. is within the acceptable range, however, the battery module is usually placed in the battery case, and the temperature inside the battery case will be over 60° C. after being heated by the sun, so that if the battery module keeps staying in such a high temperature for a long period of time will cause sharp attenuation in service life, thus resulting in a permanent damage.

It can be concluded from the above description that temperature not only has a great bearing on the service life and the efficiency of the battery, but also relatively limits the possible scope of application of the battery.

The present invention has arisen to mitigate and/or obviate the afore-described disadvantages.

### SUMMARY OF THE INVENTION

The primary objective of the present invention is to provide a battery case internal ventilation structure for controlling the temperature therein, wherein the fan and a temperature controller get power directly from the cells inside the battery case, so they can be operated independently. Whatever the cells are in use, or not in use, or being recharged, the fan can be turned on automatically to cool down the battery case whenever the temperature inside the battery case is over a predetermined reference.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a battery case internal ventilation structure in accordance with the present invention;

FIG. 2 is a cross sectional view of the battery case internal ventilation structure in accordance with the present invention;

FIG. 3 is a top view of the battery case internal ventilation structure in accordance with the present invention;

FIG. 4 is an operational view of the battery case internal ventilation structure in accordance with the present invention, wherein the fan is disposed at the outlets;

FIG. 5 is an operational view of the battery case internal ventilation structure in accordance with the present invention, wherein the fan is disposed at the inlets;

FIG. 6 shows two fans are disposed at the outlets of the battery case in accordance with the present invention;

FIG. 7 shows the fans are disposed at the outlets and the inlets of the battery case in accordance with the present invention.

### DETAILED DESCRIPTION OF THE PREFERRED EMBODIMENTS

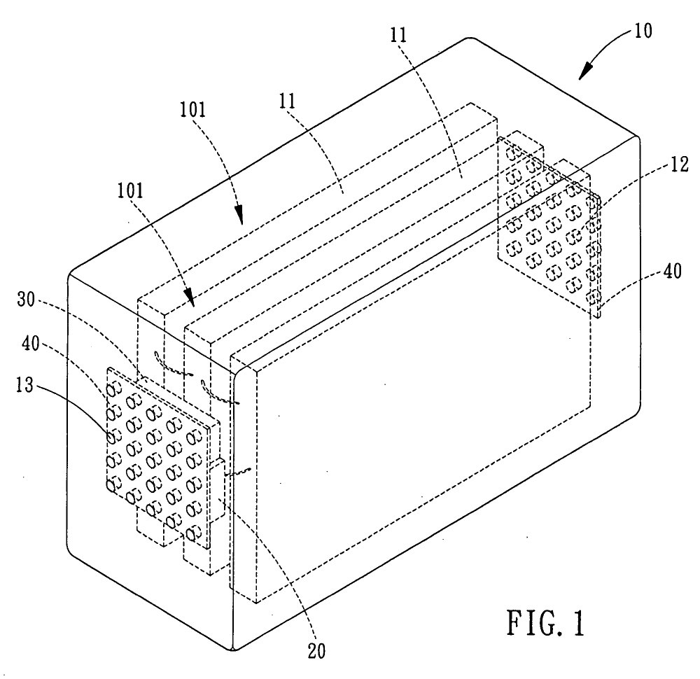

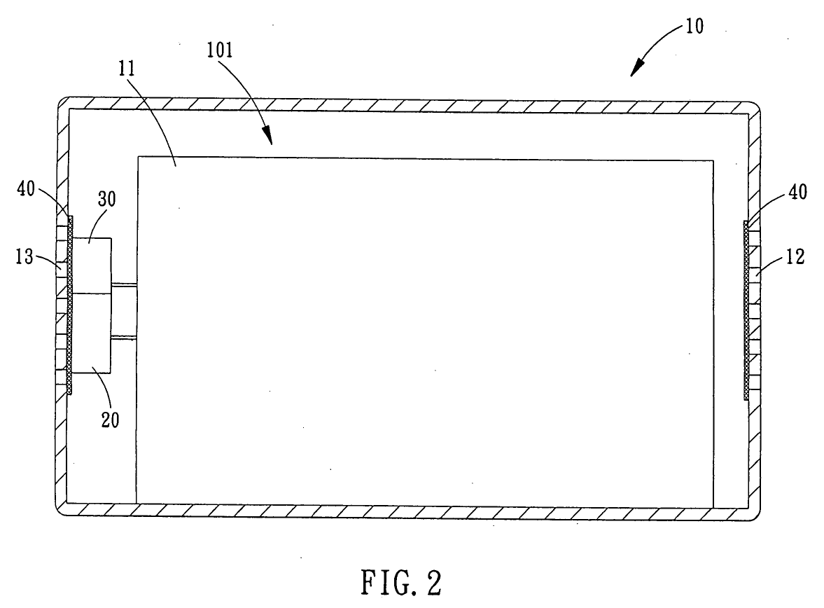

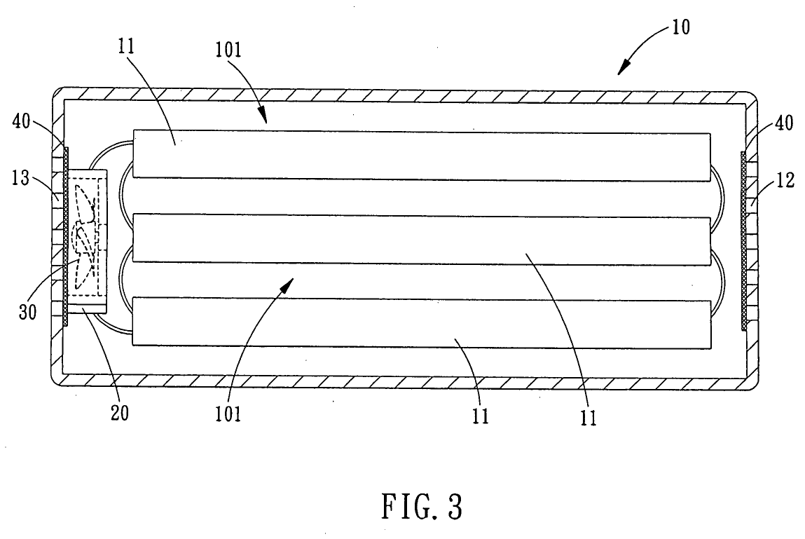

Referring to FIGS. 1-3, a battery case internal ventilation structure for controlling the temperature therein is shown and comprises: a battery case 10, a temperature controller 20 and at least a fan 30.

The battery case 10 is used for storage of a plurality of cells 11, at a side of the battery case 10 are formed a plurality of inlets 12 and at another side of the batter case 10 opposite the inlets 12 are provided a plurality of outlets 13. The respective cells 11 are separated from each other and from the internal surfaces of the battery case 10 by ventilation spaces 101.

The temperature controller 20 is electrically connected to the cells 11 for sensing and controlling the temperature inside the battery case 10 and serves to control and change the output value in response to temperature changes in the battery case. For example, the temperature controller 20 is a temperature resistor whose resistance value is changeable according to temperature, namely, the resistance value of the temperature controller will be increased with the increase of temperature, and vice versa.

The fan 30 can be disposed either at the inlets 12 or the outlets 13, and the fan 30, the temperature controller 20 and the cells 11 are connected in a loop, so that the fan 30 gets power from the cells 11 and is able to rotate under the control of the temperature controller 20.

The operation of the present invention will be explained as follows:

For example, the cells are Li-ion based and its working temperature range from −20° C. to 60° C., if the Li-ion cells are used in the battery case of an electric bicycle, the temperature inside the battery case will be over 60° C. after being heated by the sun, so that the battery module will be permanently damaged.

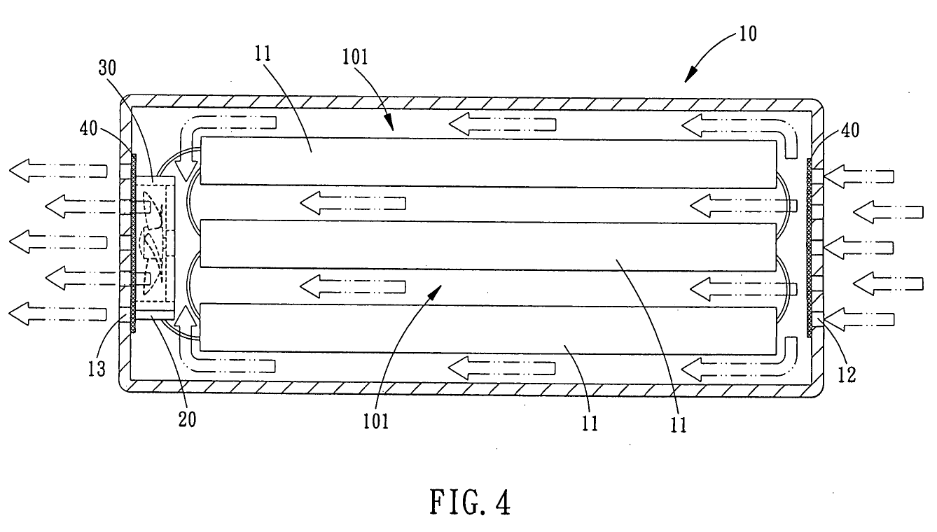

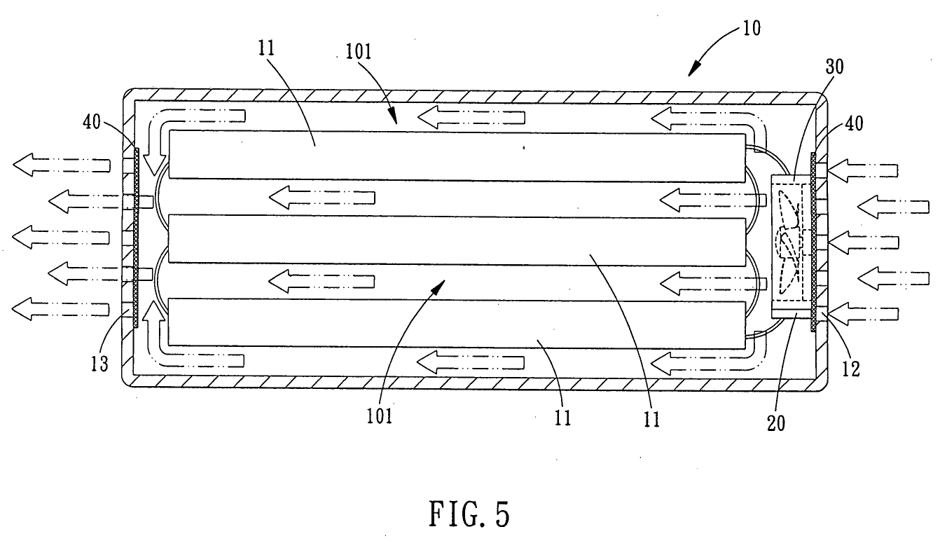

The inlets 12 and the outlets 13 are provided at either side of the sealed battery case 10, and at the inlets 12 or the outlets 13 is disposed the fan 30 (as shown in FIGS. 4 and 5). The temperature controller 20, the fan 30 and the cells 11 are connected in a loop, and the temperature controller 20 will turn on the fan 30 to exhaust heat out of the battery case 10 when the temperature in the battery case 10 is higher than a predetermined reference (such as: 50° C.).

If the fan 30 is disposed at the outlets 13 as a discharge fan (as shown in FIG. 4), fresh air will flow into and out of the battery case 10 via the inlets 12 and the outlets 1 after flowing through the ventilation spaces 101 and the surfaces of the respective cells 11. And vice versa, if the fan 30 is disposed at the inlets 12 as a extraction fan (as shown in FIG. 5), fresh air will also flow into and out of the battery case 10 via the inlets 12 and the outlets 1 after flowing through the ventilation spaces 101 and the surfaces of the respective cells 11.

In other words, the fan 30 introduces cool air into and exhausts hot air out of the battery case 10, and thus, the battery case 10 is cooled down and the temperature therein is decreased.

It is to be noted that the fan 30 and the temperature controller 20 get power directly from the cells 11 inside the battery case 10, so they can be operated independently. Whatever the cells 11 are in use, or not in use, or being recharged, the fan 30 can be turned on automatically whenever the temperature inside the battery case 10 is over a predetermined reference. This is a brand new concept to the battery industry.

In real application, a filter 40 can be provided at the inlets 12 and the outlets 13 for preventing foreign materials entering the battery case 10.

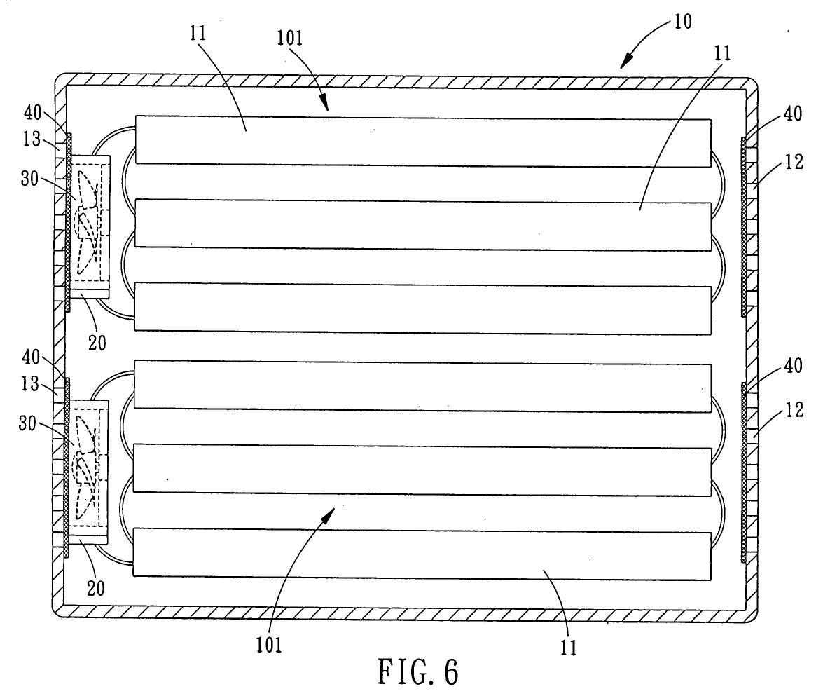

In addition, the number of the fans 13 can be varied according to needs, as shown in FIG. 6, for example, two fans 13 are disposed at the outlets 13 to improve the ventilation since there are many cells 11 in the battery case 10.

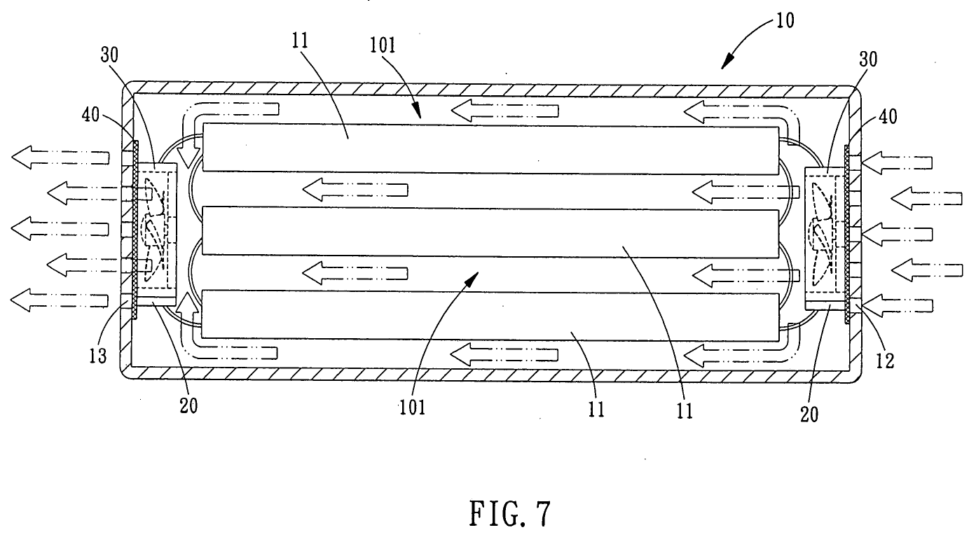

As further shown in FIG. 7, the fans also can be disposed both at the inlets 12 and the outlets 13 so as to improve the ventilation effect.

While we have shown and described various embodiments in accordance with the present invention, it should be clear to those skilled in the art that further embodiments may be made without departing from the scope of the present invention.

What is claimed is:

1. A battery case internal ventilation structure for controlling the temperature therein, comprising:
a battery case used for storage of a plurality of cells, at a side of the battery case formed a plurality of inlets and at another side of the batter case opposite the inlets provided a plurality of outlets, the respective cells separated from each other and from internal surfaces of the battery case by ventilation spaces;
a temperature controller electrically connected to the cells for sensing and controlling the temperature inside the battery case and serving to control and change output value in response to temperature changes in the battery case;
at least a fan disposed at the inlets as an extraction fan, the fan, the temperature controller and the cells being connected in a loop, so that the fan gets power from the cells and operates under the control of the temperature controller.

2. The battery case internal ventilation structure as claimed in claim 1, wherein the temperature controller is temperature resistor whose resistance value is changeable according to temperature.

3. The battery case internal ventilation structure as claimed in claim 1, wherein a filter is provided at the inlets and the outlets for preventing foreign materials entering the battery case.

4. The battery case internal ventilation structure as claimed in claim 1, wherein two fans are provided at the inlets.

5. A battery case internal ventilation structure for controlling the temperature therein, comprising:
a battery case used for storage of a plurality of cells, at a side of the battery case formed a plurality of inlets and at another side of the batter case opposite the inlets provided a plurality of outlets, the respective cells separated from each other and from internal surfaces of the battery case by ventilation spaces;
a temperature controller electrically connected to the cells for sensing and controlling the temperature inside the battery case and serving to control and change output value in response to temperature changes in the battery case;
at least a fan disposed at the outlets as a discharge fan, the fan, the temperature controller and the cells being connected in a loop, so that the fan gets power from the cells and operates under the control of the temperature controller.

6. A battery case internal ventilation structure for controlling the temperature therein, comprising:
a battery case used for storage of a plurality of cells, at a side of the battery case formed a plurality of inlets and at another side of the batter case opposite the inlets provided a plurality of outlets, the respective cells separated from each other and from internal surfaces of the battery case by ventilation spaces;
a temperature controller electrically connected to the cells for sensing and controlling the temperature inside the battery case and serving to control and change output value in response to temperature changes in the battery case;
a fan disposed at the inlets as an extraction fan, and another fan disposed at the outlets as a discharge fan, the fan, the temperature controller and the cells being connected in a loop, so that the fan gets power from the cells and operates under the control of the temperature controller.
